(19) United States
(12) Patent Application Publication
(10) Pub. No.: US 2008/0182701 A1
(43) Pub. Date: Jul. 31, 2008

(54) WORM WHEEL, GEAR, AND ELECTRIC MOTOR

(75) Inventors: Knut GERLICH, Bad Durrheim (DE); Andrej SCHNEIDER, Bonndorf (DE); Klaus PFENDLER, Bonndorf (DE); Gerhard TASCHER, Bonndorf (DE)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/018,498

(22) Filed: Jan. 23, 2008

(30) Foreign Application Priority Data
Jan. 31, 2007 (EP) 07300755.1

(51) Int. Cl. F16H 48/06; H02K 7/116

(52) U.S. Cl. 475/227; 74/421 A

(57) ABSTRACT

The invention relates to a worm wheel that is combined with an output shaft to one piece made of plastic material, to a gear with such worm wheel, and to an electric motor with such gear.

### BACKGROUND OF THE INVENTION

The invention is based on a priority application EP 07300755.1 which is hereby incorporated by reference.

The invention relates to a worm wheel.

The invention is further relates to a gear including a worm wheel and an output shaft.

The invention further relates to an electric motor with a gear.

The invention was made in the field of door automation, but can be used also in other fields.

Electric motors used for door automation often use worm gears. They do not need too much gear reduction, in our case a reduction of 12:1, where worm gears are not yet self-locking. Doors normally must not be locked. Other similar applications like window lifts for cars should be self-locking; this can be achieved with worm gears and higher reduction.

Most of possible applications are low-cost applications. But both, the worm wheel and the connection thereto, are complex parts.

The problem to be solved therefor lies in finding a solution that can be produced in a low-cost manner.

This problem is solved according to the invention by a worm wheel.

This object is further achieved by a gear including a worm wheel and an output shaft, where the worm wheel is combined with the output shaft to one piece made out of plastic material.

This problem is further achieved by an electric motor with a gear, where the gear includes a worm wheel and an output shaft, the worm wheel did the output shaft being combined to one piece made out of plastic material.

### SUMMARY OF THE INVENTION

The invention is based on the insight, that in most situations the high mechanical properties of state of the art solutions are not really necessary. And even for situations with some higher mechanical requirements a simple improvement is given.

Further embodiments of the invention are to be found in the subclaims and in the following description.

### BRIEF DESCRIPTION OF THE DRAWINGS

In the following the invention will be described with the aid of the enclosed drawings.

FIG. 1 shows a perspective view of a worm wheel according to the invention.

FIG. 2 shows a perspective view of a gear according to the invention.

FIG. 3 shows a perspective view of a motor according to the invention.

FIG. 4 shows a perspective view of an internal stiffening for a worm wheel according to the invention.

### DETAILED DESCRIPTION OF THE DRAWINGS

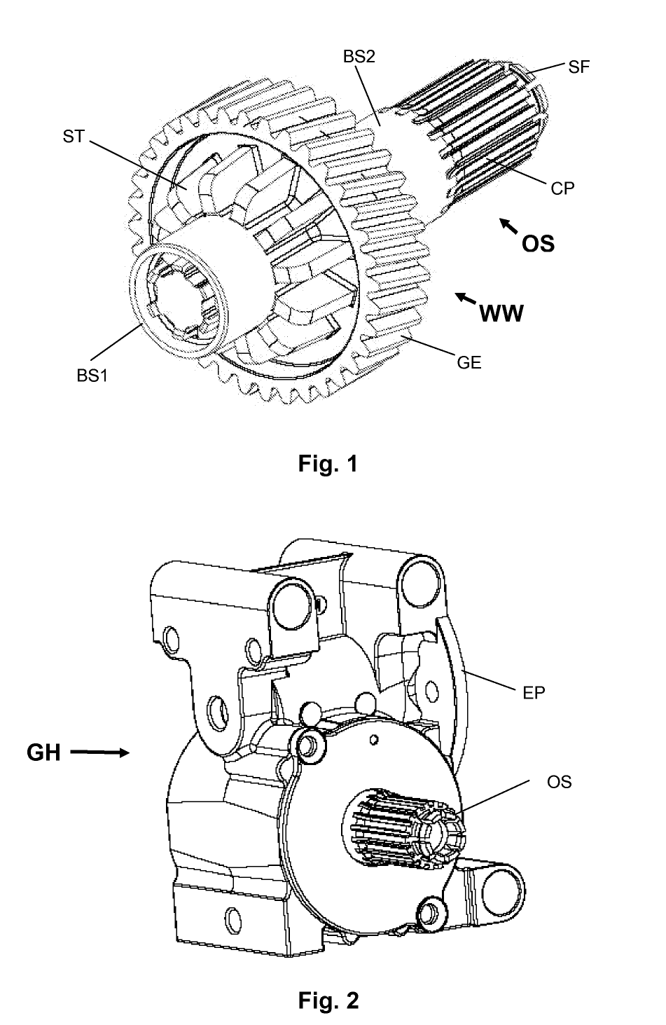

FIG. 1 shows a worm wheel according to the invention. It shows mainly the proper worm wheel WW and an output shaft OS. According to the invention these both parts are manufactured as one piece made out of plastic material. We use polyacetal (POM), especially Delrin 100™.

The worm wheel WW carries a gearing GE with helical gearing corresponding to the inclined gearing of a worm gear. As the worm wheel according to the invention is made out of plastic material, it is easy to provide it with stiffenings ST. Similar stiffenings may be applied on the rear side of the worm wheel WW. We also see a bearing shaft BS1 for applying a ball bearing and inserting it into a recess of a gear housing. An alternative could be a recess in the worm wheel WW and a shaft projecting from the gear housing with a ball bearing in between.

Opposite to the worm wheel WW, seen from the bearing shaft BS1, we see the output shaft OS. A first section of this output shaft OS is foreseen for receiving another ball bearing and acts as a bearing shaft BS2. The far end of this output shaft OS, a coupling CP, is prepared for receiving a belt pulley. The embodiment of this belt pulley receiving section is considered to contain a separate invention and will be the subject of a separate patent application.

When using steel axles (or other metal axles) it is common, to use a feather key in connection with a nut in the axle for coupling the axle with output wheels. Though this is a solution very often used, it is relatively expensive and labor-intensive. When using an output shaft made out of plastic material, one has the possibility of better adapting the output shaft to the output wheel.

Here it is proposed to implement the coupling CP as a regular series of rectangular elongated teeth, corresponding to a respective inner profile of the output wheel foreseen. Here this output shaft OS carries a snap fit SF for affixing such wheel or any other means for emitting the turning moment.

In order that the ball bearing can be assembled on the bearing shaft BS2 of the output shaft OS the outer diameter of the coupling section CP must not exceed the diameter of the bearing shaft BS2.

In the given example the bearing shaft BS1 shows an inner profile corresponding to an outer profile of an internal stiffening as to be described with reference to FIG. 4. Such stiffening can compensate in part for the reduced stability of plastic compared to metal and especially to steel.

The use of a belt drive, as foreseen in the above example, applies a bending force on the axle. Here only the material of the stiffening matters, not the cross-section of the profile. Here a plastic material with higher stability, metal, and especially steel is to be considered. We use steel for the internal stiffening.

If a high torque is to be transferred, a twist of the output shaft OS with respect to the worm wheel WW is to be expected. In this case the cross-section of the profile matters and the cross-section is to be chosen such that it hinders a twist between the internal stiffening on the one hand and the output shaft OS and the worm wheel WW on the other hand. Undulated, toothed or star-like cross-sections are examples thereof. The same also applies to the coupling CP mentioned above. Of course the outer cross-section of the internal stiffening and the inner surface of the output shaft OS and the worm wheel WW have to match. In case of using plastic material for the internal stiffening, manufacturing is no problem. In case of using steel, the drawing of a round bar steel through a suitable template is considered; the depth of the profile needs not to be very deep.

FIG. 2 shows a completed gear according to the invention. Mainly we see a gear housing GH, the output shaft OS, and an end plate EP for affixing the gear to a motor. Part of the gear housing GH is a not further specified plate for closing the housing and carrying the ball bearing for bearing the output shaft OS.

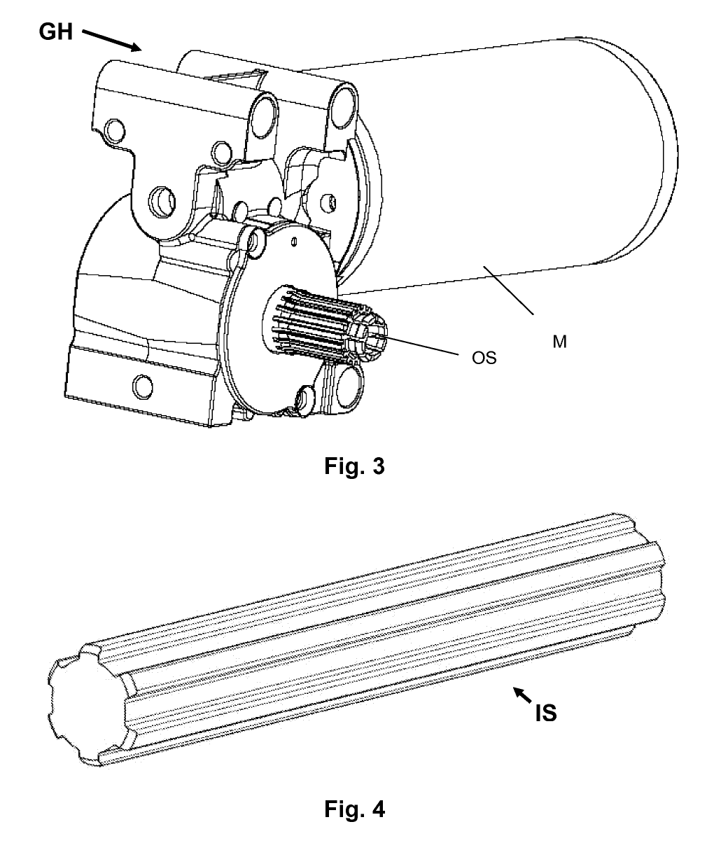

FIG. 3 shows the gear from FIG. 2 in combination with an electric motor M, the combination building an electric motor with a gear according to the invention. The end plate EP shown in FIG. 2 here fits to one of the end plates of the motor M.

FIG. 4 finally shows an example of an internal stiffening IS for optionally fortifying the plastic material of the worm wheel in combination with the output shaft.

1. A worm wheel that is combined with an output shaft to one piece made out of plastic material.

2. The worm wheel according to claim 1, characterized in that the worm wheel combined with the output shaft holds an internal stiffening.

3. The worm wheel according to claim 2, characterized in, that the internal stiffening is made out of steel.

4. The worm wheel according to claim 2, characterized in that the internal stiffening has a cross-section that hinders a twist between the worm wheel combined with the output shaft and the internal stiffening.

5. The worm wheel according to claim 1, characterized in that the output shaft has a cross-section that hinders a twist compared with an output wheel to be applied onto the shaft.

6. A gear including a worm wheel and an output shaft, where the worm wheel is combined with the output shaft to one piece made out of plastic material.

7. An electric motor with a gear, where the gear includes a worm wheel and an output shaft, the worm wheel being combined with the output shaft to one piece made out of plastic material.
